(19) United States
(12) Patent Application Publication
(10) Pub. No.: US 2019/0379434 A1
(43) Pub. Date: Dec. 12, 2019

(54) MOTION DETECTION BASED ON SPATIAL SIGNAL PROCESSING USING A WIRELESS LOCAL AREA NETWORK (WLAN) INTERFACE

(71) Applicant: QUALCOMM Incorporated, San Diego, CA (US)

(72) Inventors: Erik David Lindskog, Cupertino, CA (US); Xiaoxin Zhang, Sunnyvale, CA (US); Youhan Kim, Saratoga, CA (US); Louay Jalloul, San Jose, CA (US); Kurt Erwin Landenberger, Santa Clara, CA (US); Youngsin Lee, Seoul (KR); Srinivasarao Kode, San Jose, CA (US); Manishekar Chandrasekaran, Chennai (IN)

(21) Appl. No.: 16/432,910

(22) Filed: Jun. 5, 2019

(30) Foreign Application Priority Data
Jun. 11, 2018 (IN) 201841021717

(51) Int. Cl. H04B 7/0417; H04B 7/06

(52) U.S. Cl. CPC H04B 7/0417; H04B 7/0634; H04W 84/12; H04B 7/0626; H04B 7/0617

(57) ABSTRACT

This disclosure provides systems, methods and apparatus, including computer programs encoded on computer storage media, for detecting motion using wireless local area network (WLAN) communications. A first WLAN device having multiple antennas (radios) may determine a metric based on differences in spatial signal processing characteristics between the multiple antennas. By comparing changes in the metric over a plurality of wireless signals over time, the first WLAN device may detect motion in the environment near the first WLAN device. The spatial signal processing characteristics may be based on received WLAN communications from a second WLAN device, based on beamforming feedback from the second WLAN device, or based on wireless signal reflections detected by the first WLAN device. Various techniques may be used to adjust or mitigate random phase differences between two antennas on some tones. Motion detection based on WLAN communications may trigger activities or notifications by the first WLAN device.

### CROSS-REFERENCE TO RELATED APPLICATIONS

This patent application claims priority to Indian Provisional Patent Application No. 201841021717 filed Jun. 11, 2018 entitled “MOTION DETECTION USING CHANGES IN WIRELESS LOCAL AREA NETWORK (WLAN) SPATIAL SIGNAL PROCESSING DIFFERENCES,” and assigned to the assignee hereof. The disclosure of the prior application is considered part of and is incorporated by reference in this patent application.

### TECHNICAL FIELD

This disclosure generally relates to the field of motion detection, and more particularly, to the use of wireless local area network (WLAN) communication to detect motion.

### DESCRIPTION OF THE RELATED TECHNOLOGY

A wireless local area network (WLAN) may include several devices that communicate using wireless signals. Recent technologies have supported networking of different types of devices. For example, WLANs are being used to wirelessly network electrical systems that were not traditionally networked such as sensors, home appliances, smart televisions, light switches, thermostats, and smart meters. Sometimes referred to as Internet of Things (IoT), the networking of these electrical systems is encouraging an increasing number of innovative and useful applications.

As WLANs are adapted to support new applications, it may be useful to monitor changes in the environment in which the WLAN is deployed. Current techniques for monitoring changes in an environment may rely on specialized sensors or complex hardware. For example, a motion detector may be used to detect motion of an object in the environment.

### SUMMARY

The systems, methods, and devices of this disclosure each have several innovative aspects, no single one of which is solely responsible for the desirable attributes disclosed herein.

One innovative aspect of the subject matter described in this disclosure can be implemented as a method performed by a wireless local area network (WLAN) interface of a first WLAN device that has at least a first antenna and a second antenna. The method may include determining a first metric based, at least in part, on a first difference between first spatial signal processing characteristics regarding a first wireless signal received at a first antenna of the WLAN interface and a second antenna of the WLAN interface. The method may include determining a second metric based, at least in part, on a second difference between second spatial signal processing characteristics regarding a second wireless signal received at the first antenna and the second antenna. The method may include determining that a motion has occurred based, at least in part, on a change from the first metric to the second metric.

In some implementations, the first wireless signal may include a first WLAN communication from a second WLAN device to the first WLAN device, and the second wireless signal may include a second WLAN communication from the second WLAN device to the first WLAN device.

In some implementations, the first wireless signal and the second wireless signal may be wireless signal reflections of wireless signals transmitted from the first WLAN device.

In some implementations, the first spatial signal processing characteristics regarding the first wireless signal may be based on beamforming feedback from a second WLAN device, and the second spatial signal processing characteristics regarding the second wireless signal may be based on beamforming feedback from the second WLAN device.

In some implementations, the first difference between the first spatial signal processing characteristics may include a phase difference at the first antenna and the second antenna for the first wireless signal.

In some implementations, the method may include determining that the motion has occurred when a difference between the first metric and the second metric is above a comparison threshold.

In some implementations, determining the first metric may include determining channel state information (CSI) based on the first wireless signal. The CSI may include the first spatial signal processing characteristics for each of a first spatial link at the first antenna and a second spatial link at the second antenna. The first WLAN device may determine the first metric by determining the first difference between the first spatial signal processing characteristics associated with the first spatial link and the second spatial link. Determining the second metric may include determining CSI based on the second wireless signal. The CSI may include the second spatial signal processing characteristics for each of the first spatial link and the second spatial link. The first WLAN device may determine the second metric by determining the second difference between the second spatial signal processing characteristics associated with the first spatial link and the second spatial link.

In some implementations, determining the first metric may include receiving the first wireless signal from a second WLAN device, via a first spatial link at the first antenna and a second spatial link at the second antenna, determining a first set of channel estimates for the first spatial link and the second spatial link based on the first wireless signal, and determining the first difference between the first set of channel estimates for the first spatial link and the second spatial link. Determining the second metric may include receiving the second wireless signal from the second WLAN device, via the first spatial link at the first antenna and the second spatial link at the second antenna, determining a second set of channel estimates for the first spatial link and the second spatial link based on the second wireless signal, and determining the second difference between the second set of channel estimates for the first spatial link and the second spatial link.

In some implementations, determining the first metric may include sending the first wireless signal via the WLAN interface, where the first wireless signal causes a reflection from a stationary object that is received as a first wireless signal reflection, receiving the first wireless signal reflection via a first spatial link at the first antenna and a second spatial link at the second antenna, determining a first set of channel estimates for the first spatial link and the second spatial link based on the first wireless signal reflection, and determining the first difference between the first set of channel estimates for the first spatial link and the second spatial link. In some implementations, determining the second metric may include sending the second wireless signal via the WLAN interface, where the second wireless signal causes a reflection that is received as a second wireless signal reflection, receiving the second wireless signal reflection via the first spatial link at the first antenna and the second spatial link at the second antenna, determining a second set of channel estimates for the first spatial link and the second spatial link based on the second wireless signal reflection, and determining the second difference between the second set of channel estimates for the first spatial link and the second spatial link.

In some implementations, determining the first metric may include sending the first wireless signal to a second WLAN device, receiving, from the second WLAN device, first compressed beamforming information in response to the first wireless signal, and determining the first metric based on the first compressed beamforming information. Determining the second metric may include sending the second wireless signal to the second WLAN device, receiving, from the second WLAN device, second compressed beamforming information in response to the second wireless signal, and determining the second metric based on the second compressed beamforming information.

In some implementations, determining the first metric may include sending the first wireless signal to the second WLAN device, receiving, from the second WLAN device, a first dominant singular vector from a first channel matrix associated with beamforming information regarding the first wireless signal, and determining the first metric based on the first dominant singular vector. Determining the second metric may include sending the second wireless signal to the second WLAN device, receiving, from the second WLAN device, a second dominant singular vector from a second channel matrix associated with beamforming information regarding the second wireless signal, and determining the second metric based on the second dominant singular vector.

In some implementations, determining the first metric may include averaging values in the first spatial signal processing characteristics for a set of tones before determining the first difference between the first antenna and the second antenna. Determining the second metric may include averaging values in the second spatial signal processing characteristics for a same set of tones before determining the second difference between the first antenna and the second antenna.

In some implementations, determining the first metric may include discarding values in the first spatial signal processing characteristics for a subset of tones before determining the first difference between the first antenna and the second antenna. Determining the second metric may include discarding values in the second spatial signal processing characteristics for a same subset of tones before determining the second difference between the first antenna and the second antenna.

In some implementations, the method may include determining the set of tones in an orthogonal frequency division multiplexing (OFDM) transmission that are associated with low signal power below a signal power threshold, and discarding the values in the first spatial signal processing characteristics for the set of tones.

In some implementations, the method may include determining a random phase difference at the first WLAN device, determining that a difference from the first metric to the second metric is due to the random phase difference, and adjusting the first metric or the second metric to remove the random phase difference.

In some implementations, determining that the difference from the first metric to the second metric is due to the random phase difference may include determining a range for the random phase difference, the range having a positive range value and a negative range value, and determining that the difference from the first metric to the second metric is more than half of the positive range value or less than half of the negative range value.

In some implementations, determining the first metric may include determining a first set of phase differences in first channel state information (CSI) for the first wireless signal, the first set of phase differences based on differences in phase values in the first CSI between the first antenna and the second antenna. In some implementations, determining the second metric may include determining a second set of phase differences in second CSI for the second wireless signal, the second set of phase differences based on differences in phase values in the second CSI between the first antenna and the second antenna. Determining that a motion has occurred may include determining a set of differential values indicating differences between the first set of phase differences and the second set of phase differences, determining a set of delta values indicating differences between the differential values of two adjacent tones, discarding delta values associated with tones that have a magnitude less than a tone magnitude threshold, determining an average of the remaining delta values, and determining that motion has occurred if the average of the remaining delta values is above a motion detection threshold.

In some implementations, the method may include determining a plurality of metrics associated with a sequence of wireless signals. Each metric of the plurality of metrics may be based on based on a difference between spatial signal processing characteristics for a respective wireless signal at the first antenna and the second antenna. The method may include determining a pattern in the plurality of metrics over the sequence of wireless signals, and determining the motion based on a change in the pattern.

In some implementations, determining the pattern may include determining a multi-dimensional ellipsoid shape representing the plurality of metrics. Determining the motion may include comparing changes in a surface of the multi-dimensional ellipsoid shape over time.

In some implementations, the method may include using the plurality of metrics as indices for a Hausdorff distance calculation. Determining the motion may include comparing a result of the Hausdorff distance calculation with a comparison threshold.

In some implementations, the method may include determining a direction of the motion based, at least in part, on the pattern.

In some implementations, the first wireless signal and the second wireless signal may be beacon messages received by the first WLAN interface from an access point (AP).

In some implementations, multiple spatial links may exist between the first WLAN device and the second WLAN device. The method may include determining a plurality of link pairs from among the multiple spatial links. The method may include, for each link pair between the first WLAN device and the second WLAN device, determining the first metric and the second metric associated with respective spatial links in the link pair, and determining the change from the first metric to the second metric for the link pair. The method may include detecting the motion in the environment based, at least in part, on a quantity of the link pairs that have the change above a comparison threshold.

In some implementations, detecting the motion may include detecting the motion when the quantity of the link pairs that have the change above the comparison threshold is above a threshold quantity.

In some implementations, the first WLAN device may be part of a networked electrical system (such as a television). The method may include activating a feature of the networked electrical system in response to determining that the motion has occurred.

In some implementations, the first metric is a baseline metric determined at a time when no object is in motion.

Aspects of the subject matter described in this disclosure can be implemented a device, a software program, a system, or other means to perform the above-mentioned methods.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a system diagram of a wireless local area network (WLAN) including an example WLAN device capable of detecting motion using spatial signal processing characteristics

FIG. 2A shows an example message flow in which motion is detected using WLAN communications.

FIG. 2B shows an example message flow in which motion is detected using reflections of wireless signals sent and received by a WLAN interface.

FIG. 2C shows an example message flow in which motion is detected using WLAN beamforming feedback.

FIG. 3 shows an example chart in which motion is detected based a change of dual antenna phase difference over a plurality of WLAN frames.

FIG. 4 shows an example flowchart for detecting motion using spatial signal processing characteristics.

FIG. 5 shows a system diagram of an example WLAN with multiple spatial links for detecting motion.

FIG. 6 shows a flowchart with descriptions of example calculations for determining a metric based on spatial signal processing characteristics.

FIG. 7 shows a flowchart with example operations for detecting motion based on channel state information while mitigating false positives associated with random phase differences.

FIG. 8 shows an example conceptual message format with feedback for detecting motion based on spatial signal processing characteristics.

FIG. 9 shows a system diagram of a WLAN interface capable of detecting motion using reflections of wireless signals.

FIG. 10 shows a block diagram of an example electronic device for implementing aspects of this disclosure.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some examples in this disclosure may be based on wireless local area network (WLAN) communication according to the Institute of Electrical and Electronics Engineers (IEEE) 802.11 wireless standards. However, the described implementations may be implemented in any device, system or network that is capable of transmitting and receiving radio frequency (RF) signals according to any communication standard, such as any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing 3G, 4G or 5G, or further implementations thereof, technology.

Recently, techniques have been developed to detect motion in the environment based on diversity metrics associated with wireless signals. For example, a receiving WLAN device may receive a plurality of wireless frames. The wireless signal that carries each frame may be used to determine a channel impulse response (CIR) of the wireless channel. For example, the wireless signal may be carried over multiple tones (sometimes referred to as frequencies). Multiple tones may be combined to form an orthogonal frequency division multiplexing (OFDM) signal. A CIR may be determined by performing an Inverse Fourier Transform (IFT) on the wireless signal that carries a frame. The CIR may be a time-domain representation of the channel frequency response. By comparing differences in CIR over a plurality of wireless frames, a WLAN device may detect a change in the wireless channel that suggests motion of an object in the environment. While CIR can be effective in detecting motion, the techniques may be improved in communication systems that utilize multiple spatial links. For example, some WLAN devices have multiple antennas (sometimes also referred to as multiple radios) that are capable of sending or receiving wireless signals with spatial diversity. In some implementations, the use of multiple antennas can reduce false positives while providing capability for improved motion detection techniques.

A WLAN device may determine a diversity metric based on spatial signal processing characteristics (which also may be referred to as a spatial signature) for wireless signals sent or received by a WLAN interface having multiple antennas. Spatial signal processing characteristics refers to the differences (such as phase, amplitude, or the like) in the signal processing between a first antenna and a second antenna for the same wireless signal. In some implementations, the spatial signal processing characteristics may be related to beamforming or other spatial diversity information which involves multiple antennas at a WLAN device.

In one aspect of this disclosure, a WLAN device may be capable of detecting changes (such as motion) within an environment based on changes in the spatial signal processing characteristics. For example, a WLAN device may detect a motion in the environment by comparing changes in the spatial signal processing characteristics. The changes in spatial signal processing may be detected based on WLAN communications or wireless signals detectable by a WLAN interface. For example, a series of wireless signals detected by the WLAN interface may form a baseline pattern which is altered when there is motion in the environment.

In some implementations, a WLAN device may determine a first metric associated with a first wireless signal (such as a first WLAN communication). The first metric represents a difference between the signal at the first antenna and the second antenna. The first metric can be determined from the spatial signal processing characteristics associated with the first wireless signal. Later, the WLAN device may send or receive a second wireless signal (such as a second WLAN communication) which has different spatial signal processing characteristics at the first antenna and the second antenna. The WLAN device may determine a second metric associated with the second wireless signal. The second metric represents a difference between the signal for the second wireless signal at the first antenna and the second antenna. The WLAN device may detect (or infer) motion in the environment based on a comparison of the first metric (for the earlier wireless signal) and the second metric (for the later wireless signal). For example, if the change between the first metric and the second metric is above a comparison threshold, the change may be the result of motion of an object in the environment. In some implementations, the object in motion is a person near either the first WLAN device or the second WLAN device. In some implementations, the object in motion may be a third WLAN device (such as a handheld mobile device).

In another aspect of this disclosure, the changes in spatial signal processing may be detected based on wireless signal reflections detected by a WLAN interface. The wireless signals may not be used for WLAN communication between two WLAN devices, but rather may be wireless signals sent and received by antennas of a WLAN interface in a single WLAN device. For example, a single WLAN device may transmit wireless signals and receive reflections of those wireless signals which are reflected by objects in the environment. A motion in the environment may change the spatial signal processing characteristics of the wireless signal reflections. By comparing spatial signal processing characteristics over time, the WLAN device may infer motion when the spatial signal processing characteristics change. This technique makes use of a multi-antenna WLAN device to detect changes in the spatial signal processing characteristics associated with different antennas.

This disclosure describes several techniques for determining changes in the environment based on spatial signal processing characteristics. The spatial signal processing characteristics may be based on channel state information (CSI), channel estimates, or beamforming feedback. In some implementations, the spatial signal processing characteristics may be related to channel properties, such as a channel impulse response (CIR) or channel frequency response (CFR), that impact how a wireless signal is processed differently by different antennas. The spatial signal processing characteristics may be determined from WLAN communications or wireless signal reflections. For example, a WLAN device may determine spatial signal processing characteristics from WLAN communications received from another WLAN device or based on feedback that it receives from the other WLAN device based on WLAN communications that it has sent.

In some implementations, the spatial signal processing characteristics may be related to beamforming information. For example, a first WLAN device may transmit WLAN frames to a second WLAN device. The second WLAN device may provide beamforming information (or compressed beamforming information) as feedback to the first WLAN device. Compressed beamforming feedback (CBF) refers to a technique for sending a subset of the beamforming information that is used by the first WLAN device to determine spatial signal processing characteristics. In this disclosure, the CBF can be used to determine the first metric (antenna-to-antenna differences for a first WLAN frame) and the second metric (antenna-to-antenna differences for a subsequent, second WLAN frame). By observing changes between the first metric and the second metric, the WLAN device may detect (or infer) motion of an object in the environment.

There are many metrics or algorithms to determine changes in the spatial signal diversity metrics. For example, the CBF may be reduced to a comparison metric by performing a root mean square (RMS) on the vectors in the CBF. In some implementations, a dominant singular vector from the CBF may be used to calculate the metric representing the difference between signal at multiple antennas. In some implementations, the metric may be calculated based on vector information and scale information included in the CBF.

In some implementations, the metrics for a plurality of wireless signals may be used to determine a multi-dimensional ellipsoid representation of the spatial signal processing characteristics. By comparing changes in the surfaces (or boundaries) of the multi-dimensional ellipsoid over a series of WLAN frames, the WLAN device can determine that the spatial signal processing differences have changed as a result of motion in the environment. A Hausdorff distance calculation can be performed to observe changes in the multi-dimensional ellipsoid representation of the metrics. In some implementations, the wireless signals are modulated as OFDM signals using multiple tones. A calculation to determine the metrics may be based on part or all of the tones used for the OFDM signals. For example, calculation may include averaging or discarding some values in the spatial signal processing characteristics for a set of tones associated with OFDM signals.

In some implementations, a first WLAN device can trigger a second WLAN device to send a channel state feedback metric based on spatial signal diversity. For example, a previously undefined metric may be defined in a technology standard to support motion-related spatial signal feedback. In some implementations, the channel state feedback metric may be a dominant singular vector from a channel matrix associated with channel estimates or beamforming information. The first WLAN device may send a first wireless frame to the second WLAN device. The second WLAN device may provide a first dominant singular vector associated with the first wireless frame in a response message to the first WLAN device. Subsequently, the first WLAN device may send a second wireless frame to the second WLAN device. The second WLAN device may provide a second dominant singular vector associated with the second wireless frame in a response message to the first WLAN device. The baseline spatial signal diversity metric and the new spatial signal diversity metric may be based on the first dominant singular vector and the second dominant singular vector, respectively. Because the channel state feedback metric can be triggered by the first WLAN device, the first WLAN device can manage the periodicity for determining and comparing the spatial signal diversity metrics.

In some implementations, a WLAN device may determine a pattern in the changes of the spatial differences over a plurality of wireless signals over time. Depending on the shape of the pattern, the WLAN device may learn more about the motion of the object in the environment. For example, the shape of the pattern may be related to a direction of the motion (left to right, right to left, moving closer to the first WLAN device, moving closer to the second WLAN device, moving away, or the like). Furthermore, the shape of the pattern may provide information about the size or composition of the object.

In some implementations, a first WLAN device and a second WLAN device may both have multiple antennas and can transmit or receive multiple spatial streams. Each combination of a spatial stream (SS) and receiving (RX) antenna may have different signal processing characteristics. A spatial link refers to a path from a SS to an RX antenna. The spatial links may be grouped in pairs such that each pair of spatial links can be used to calculate a spatial signal diversity metric representing a difference in the signal processing characteristics associated with the pair of spatial links. For each pair of spatial links, a first metric (representing antenna differences for a first wireless signal or a first WLAN communication) and a second metric (representing antenna differences for a second wireless signal or a second WLAN communication) may be compared to determine changes. The first WLAN device may determine that motion has occurred in the environment based on how many pairs of spatial links have a change above a comparison threshold. For example, if the quantity of pairs having the change is above a threshold quantity, then the first WLAN device may detect (or infer) motion. The threshold quantity may be based on how many pairs of spatial links are present in the channel.

Particular implementations of the subject matter described in this disclosure can be implemented to realize one or more of the following potential advantages. Any type of WLAN device (including IoT devices) having more than one antenna may be capable of detecting motion using WLAN communications or reflected wireless signals. For example, a television may have a multi-radio WLAN interface and may be capable of detecting motion in the environment near the television. In response to detecting the motion, the television may be configured to activate a feature of the television (such as turn on when motion is detected, or turn off after a period of time when motion has stopped). In another example a camera may have a multi-radio WLAN interface and may be capable of detecting motion in the environment near the camera. In response to detecting the motion, the camera may be configured to identify the type of the motion, such as motion caused by human. The camera may be configured to take a picture or video, upload to a cloud, or send an alert. Alternatively, if the camera determines the motion is caused by bird or tree, the camera may refrain from performing the above-referenced features. In another example a home security detector may have a multi-radio WLAN interface and may be capable of detecting motion in the environment near the home security detector. In response to detecting the motion, the home security detector may be configured to identify the type of the motion, such as door open/close, window open/close, or other condition for triggering an alert. Other types of devices and applications could make use of motion detection based on wireless signals (such as health monitoring to detect a person that has fallen down, indoor location tracking using motion detection, or the like).

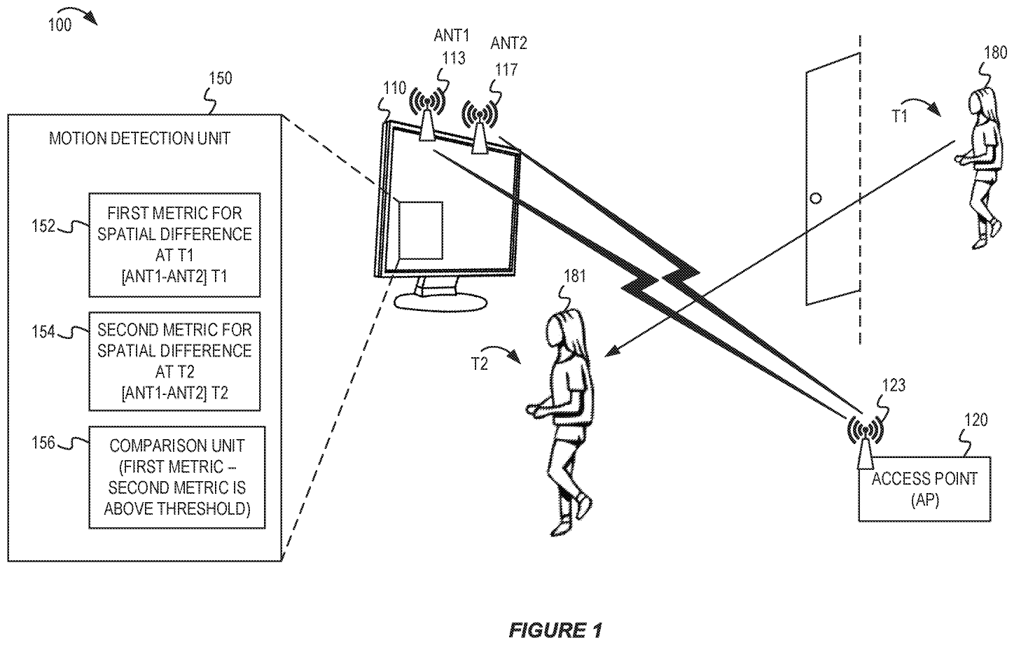

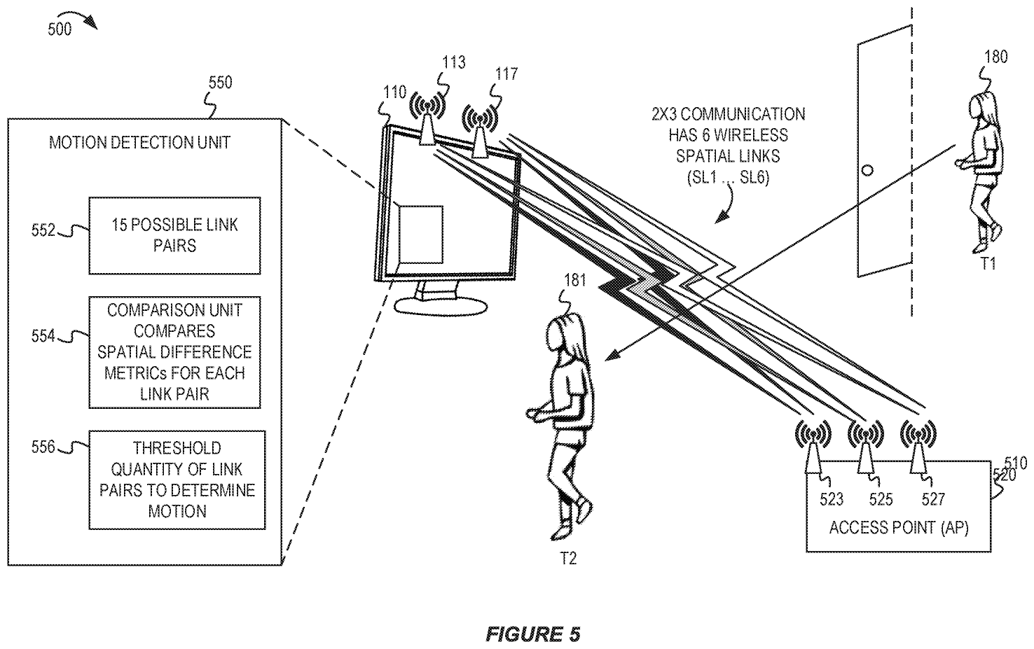

FIG. 1 shows a system diagram of a WLAN including an example WLAN device capable of detecting motion using spatial signal processing characteristics. The system 100 includes a first WLAN device 110 (depicted as a television) with multiple antennas (first antenna 113 and second antenna 117) for sending and receiving WLAN communications. The system 100 also includes a second WLAN device 120 (depicted as an access point, AP). The second WLAN device 120 includes one antenna 123. In other examples (including those described in FIG. 5), the first WLAN device 110 and the second WLAN device 120 may have different quantities of antennas. In some implementations, the antennas may be used with multiple-input-multiple-output (MIMO) wireless channels to form multiple spatial links. While FIG. 1 shows the first WLAN device 110 as a television, any type of WLAN device may be used with the techniques in this disclosure.

The first WLAN device 110 includes a motion detection unit 150 capable of performing the operations described in this disclosure. For example, the motion detection unit 150 may calculate a first metric 152 for spatial difference at time T1. In the example of FIG. 1, a person 180 is outside of the environment near the first WLAN device 110 or the second WLAN device 120 (such as in another room or outside of range of the WLAN). The second WLAN device 120 may transmit a first WLAN communication which is received by both the first antenna 113 and the second antenna 117. The motion detection unit 150 may perform signal processing on the first WLAN communication and determine channel estimates or other spatial signal processing characteristics that represent how the signal is different at the first antenna 113 and the second antenna 117. For example, the phase difference between the antennas may be determined. The motion detection unit 150 may determine a first metric based on the phase difference (or other difference in spatial signal processing characteristics) between the signal received by the first antenna 113 and the second antenna 117.

Later, the person 180 may enter the environment (shown as person 181 in motion at time T2). A second WLAN communication from the second WLAN device 120 to the first WLAN device 110. However, because of the motion of the person 181, the spatial signal processing characteristics for the first antenna 113 and the second antenna 117 may be different for the second WLAN communication (compared to the spatial signal processing characteristics determined for the first WLAN communication). The motion detection unit 150 may determine a second metric 154 based on the spatial signal processing characteristics which represents how the second WLAN communication signal is different at the first antenna 113 and the second antenna 117.

The motion detection unit 150 may include a comparison unit 156 which determines that there is a change between the first metric and the second metric. If the difference between the first metric and the second metric is above a comparison threshold, the motion detection unit 150 may determine that the person 181 is in motion near either the first WLAN device 110 or the second WLAN device 120. Remembering that each metric represents a difference (in spatial signal processing characteristics at the first antenna 113 and the second antenna 117), the motion detection unit 150 may determine a “difference of differences”—the difference (between two WLAN communications) of differences (of the spatial signal processing characteristics between antennas for each WLAN communication).

In some implementations, the first WLAN communication and the second WLAN communication may be beacon messages transmitted by the second WLAN device 120. In some implementations, the WLAN communications may be sounding messages, null data packets (NDP), acknowledgement packets (ACK), or other types of messages which can be received by the multi-antenna first WLAN device 110. In some implementations, a new type of message may be defined in a technical specification to provide support for motion detection.

Although FIG. 1 shows the first WLAN device 110 and the second WLAN device 120 as belonging to a same WLAN, the WLAN devices may not be wirelessly associated with the same WLAN. For example, the second WLAN device 120 may be an AP that is broadcasting beacon frames or other broadcast messages which can be received by the first WLAN device 110 regardless of whether the first WLAN device 110 can respond or associate with the AP. In some implementations, the first WLAN device 110 may be associated with a different network or wireless channel but may still be capable of receiving wireless signals from the second WLAN device 120 and determining spatial signal processing characteristics for the signal at the first antenna 113 and the second antenna 117.

In some implementations, the first WLAN device 110 may use channel estimate feedback or beamforming information feedback from the second WLAN device 120. For example, the first WLAN device 110 may transmit (using the first antenna 113 and the second antenna 117) a first WLAN communication to the second WLAN device 120. The second WLAN device 120 may respond with the channel estimate feedback or beamforming information feedback to indicate how the second WLAN device 120 received the first WLAN communication. The channel estimate feedback or beamforming information feedback may be used as spatial signal processing characteristics to represent a difference between the first antenna 113 and the second antenna 117. Thus, the first metric 152 may be determined from the channel estimate feedback or beamforming information feedback. Similarly, the second WLAN device 120 may respond with channel estimate feedback or beamforming information feedback associated with a second WLAN communication from the first WLAN device 110 to the second WLAN device 120. The channel estimate feedback or beamforming information feedback for the second WLAN communication can be used to determine the second metric 154. In this disclosure, the first WLAN device 110 may be capable of detecting motion in the environment using either received WLAN communications or feedback regarding sent WLAN communications. In some implementations, the feedback may be compressed beamforming information (CBF). Current wireless technical specifications for WLAN communications provide a mechanism for CBF to be shared to a WLAN device having multiple antennas. Thus, in some implementations, the motion detection techniques in this disclosure can be used by calculating spatial difference metrics using CBF.

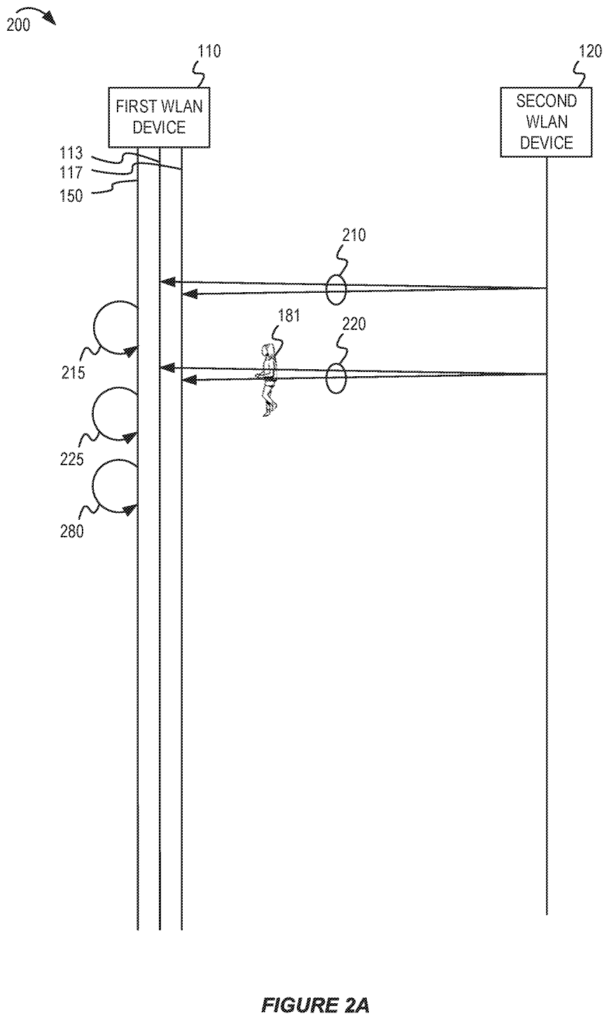

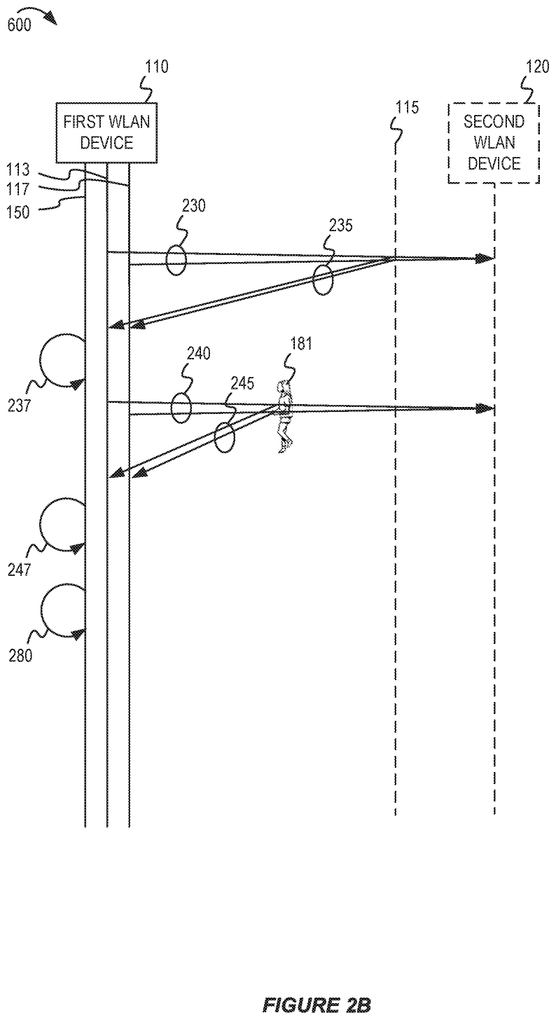

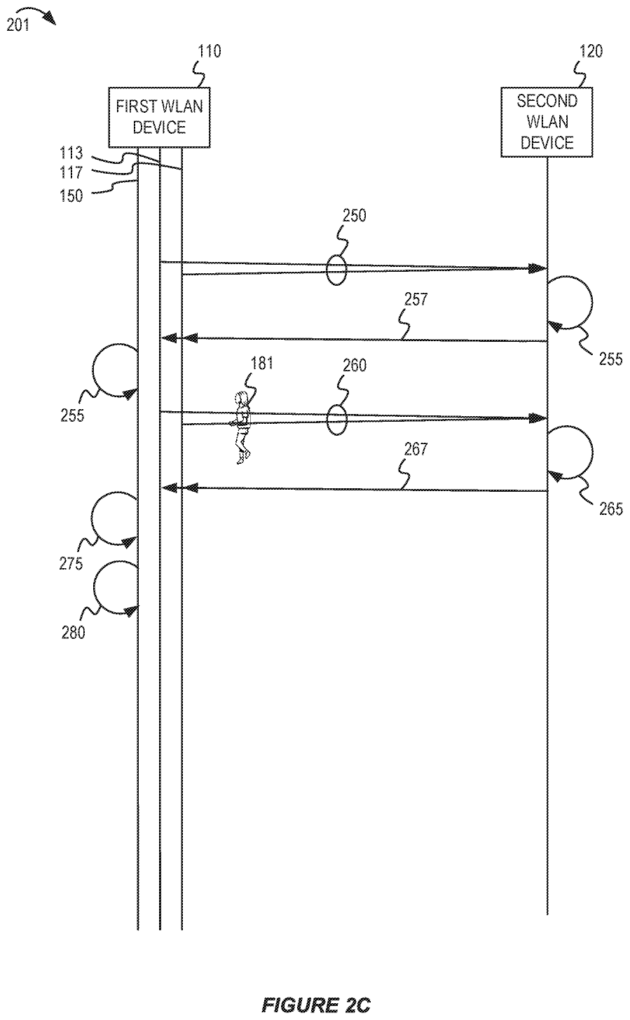

FIG. 2A shows an example message flow in which motion is detected using WLAN communications. The message flow diagram 200 illustrates the examples described above with regard to FIG. 1. The message flow diagram 200 includes the first WLAN device 110 and the second WLAN device 120 as described in FIG. 1. In the example of FIG. 2A, the second WLAN device 120 may send a first WLAN communication 210 which can be received by a first antenna 113 and a second antenna 117.

At process 215, the motion detection unit 150 of the first WLAN device 110 may determine a first metric associated with the first WLAN communication 210 based on the differences in the spatial signal processing characteristics at the first antenna 113 and the second antenna 117. In some implementations, a plurality of WLAN communications (not shown) may be received by the first WLAN device 110 and the motion detection unit 150 may determine a baseline metric which represents spatial signal processing characteristics when not motion is present. Subsequently, the second WLAN device 120 may transmit a second WLAN communication 220 at a time when a person 181 is in motion in the environment. The second WLAN communication 220 is received by the first antenna 113 and the second antenna 117. At process 225, the motion detection unit 150 may determine a second metric associated with the second WLAN communication 220 based on the differences in the spatial signal processing characteristics at the first antenna 113 and the second antenna 117. At process 280, the motion detection unit 150 may determine that there is motion in the environment by determining a change from the first metric (or baseline metric) to the second metric.

FIG. 2B shows an example message flow in which motion is detected using reflections of wireless signals sent and received by a WLAN interface. This technique may be similar to radar, except that it makes use of a multi-antenna WLAN device to detect changes in the spatial signal processing characteristics associated with different antennas. A first WLAN device 110 may transmit a wireless signal via one or multiple antennas (such as the first antenna 113 and the second antenna 117) and then observe their reflections of the wireless signal using the antennas. The wireless signal may be WLAN communications directed to a second WLAN device 120 (regardless of whether the second WLAN device 120 is present in the WLAN), or may be broadcast transmissions from the first WLAN device 110 with no intended recipient. For example, the wireless signal may be formatted as a WLAN communication with a reserved address or to a broadcast address. In some implementations, the wireless signal may be formatted differently from a WLAN communication—such as a wireless signal transmitted from the WLAN interface without adhering to a technical specification for the WLAN.

The first WLAN device 110 may transmit a first wireless signal 230. A stationary object 115 may cause part of the signal associated with the first wireless signal 230 to be reflected back to the first WLAN device 110. The first wireless signal reflection 235 may be reflected off the stationary object 115 and back to the first WLAN device 110. The first WLAN device 110 may receive the first wireless signal reflection 235 using both the first antenna 113 and the second antenna 117. At process 237, the first WLAN device 110 (for example, using the motion detection unit 150) may determine a first metric based on the first wireless signal reflection 235. The first metric represents a difference in the spatial signal processing characteristics at the first antenna 113 and the second antenna 117 when receiving the first wireless signal reflection 235. Subsequently, the first WLAN device 110 may transmit a second wireless signal 240 at a time when a person 181 is in motion in the environment near the first WLAN device 110. A second wireless signal reflection 240 may be reflected off the person 181 (as a second wireless signal reflection 245) and back to the first WLAN device 110. At process 247, the first WLAN device 110 may determine a second metric based on the second wireless signal reflection 245. The second metric may represent a difference in the spatial signal processing characteristics at the first antenna 113 and the second antenna 117 when receiving the second wireless signal reflection 245. At process 280, the motion detection unit 150 may determine that there is motion in the environment by determining a change from the first metric to the second metric. In this scenario, because the first WLAN device 110 is using a radar-type technique to determine the motion, the first WLAN device 110 may infer that there is motion near the first WLAN device 110 (rather than the second WLAN device 120) based on the changes in the spatial signal processing characteristics.

FIG. 2C shows an example message flow in which motion is detected using WLAN beamforming feedback. The message flow diagram 201 includes the first WLAN device 110 and the second WLAN device 120 as described in FIG. 1. In the example of FIG. 2B, the first WLAN device 110 may send a first WLAN communication 250 to the second WLAN device 120.

At process 255, the second WLAN device 120 may determine channel estimates or beamforming information based on the first WLAN communication 250. The second WLAN device 120 may transmit a first feedback message 257 to the first WLAN device 110. The first feedback message 257 may include a feedback value (such as beamforming information, compressed beamforming information (CBF), or a first dominant singular vector from a first channel matrix associated with the beamforming information). At process 255, the first WLAN device 110 may determine a first metric based on the feedback value (beamforming information, CBF, or dominant singular vector included in the first feedback message 257. Subsequently, the first WLAN device 110 may transmit a second WLAN communication 260 at a time when a person 181 is in motion in the environment. At process 265, the second WLAN device 120 may determine channel estimates or beamforming information based on the second WLAN communication 260. The second WLAN device 120 may transmit a second feedback message 267 to the first WLAN device 110. The second feedback message 267 may include beamforming information, CBF, or a second dominant singular vector regarding the second WLAN communication 260. At process 275, the first WLAN device 110 may determine a second metric based on the beamforming information, CBF, or dominant singular vector included in the first feedback message 257. At process 280, the motion detection unit 150 may determine that there is motion in the environment by determining a change from the first metric to the second metric.

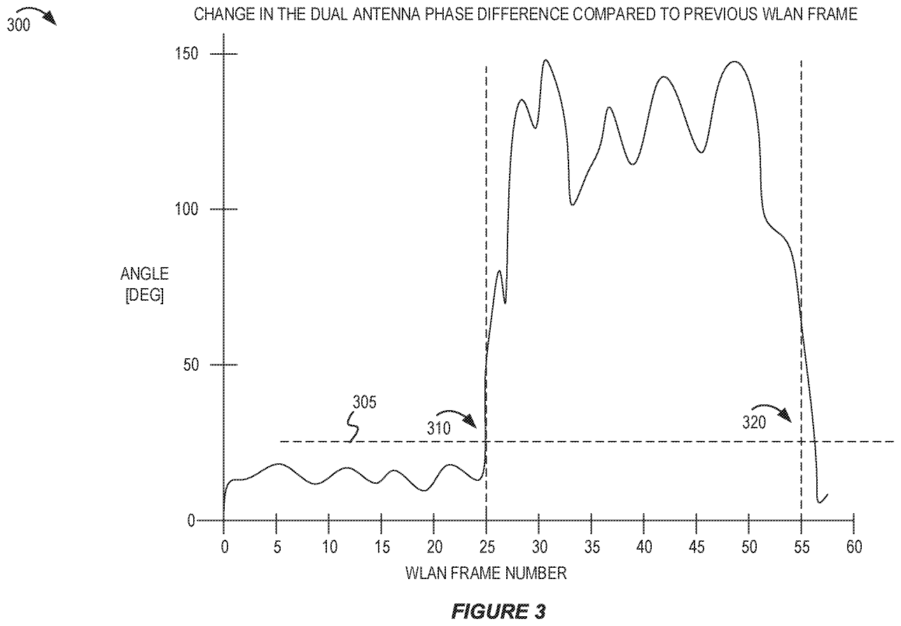

FIG. 3 shows an example chart in which motion is detected based a change of dual antenna phase difference over a series of WLAN frames. The chart 300 shows a series of WLAN frame numbers along the x-axis and an angle (degree) measurement along the y-axis. The angle (degree) measurement shows the difference in signal between each antenna of a dual antenna receiver or transmitter. For example, the spatial signal processing characteristics may indicate approximately a 15-20 degree difference between the two antennas of a dual antenna device. For WLAN frame numbers 0-25, the dual antenna phase difference from one WLAN frame number to the next WLAN frame number shows relatively little change (less than 25 degrees). At 310, the phase difference for WLAN frame number 25 changes above a comparison threshold 305 at the WLAN frame number 26. For example, the phase difference between each antenna goes to 100-150 degree difference for several WLAN frames. During that period of time (associated with the time period for WLAN frames 26-55), the first WLAN device may determine that motion in the environment is causing the change in phase difference above the comparison threshold 305. At 320, the phase difference for WLAN frame 55 drops, which may indicate that motion has stopped or that the person is no longer in the environment.

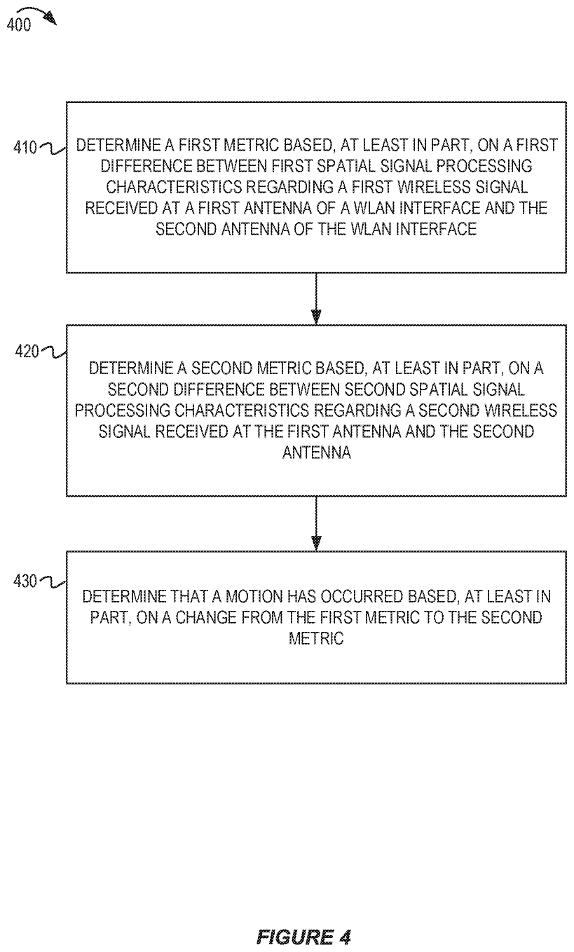

FIG. 4 shows an example flowchart for detecting motion using spatial signal processing characteristics. The flow chart 400 includes example operations which may be performed by a WLAN interface of a first WLAN device (such as the first WLAN device 110) that has at least a first antenna and a second antenna.

At block 410, the first WLAN device may determine a first metric based on a first difference between first spatial signal processing characteristics regarding a first wireless signal received at a first antenna of a WLAN interface and a second antenna of the WLAN interface. In some implementations, the first wireless signal may be based on a first WLAN communication from a second WLAN device to the first WLAN device. In some implementations, the first wireless signal may be based on a wireless signal reflection of a wireless signal transmitted by the first WLAN interface. In some implementations, the first metric may be based on beamforming feedback from a second WLAN device based on a first WLAN communication from the first WLAN device to the second WLAN device. The spatial signal processing characteristics may be channel estimates, channel state information, channel estimate feedback, beamforming information, compressed beamforming feedback, or other feedback (such as a dominant singular vectors) from another WLAN device. The first metric may be determined using various algorithms or calculations described in this disclosure.

At block 420, the first WLAN device may determine a second metric based on a second difference between second spatial signal processing characteristics regarding a second wireless signal received at the first antenna and the second antenna. The same type of spatial signal processing characteristics and calculations may be performed to determine the second metric as was used for the first metric.

At block 430, the first WLAN device may determine that motion has occurred based on a change from the first metric to the second metric. The change represents a difference in the spatial signature difference, and the change may indicate an occurrence of motion in the environment. In some implementations, the first WLAN device may activate a feature or send a message in response to detecting the motion. For example, the first WLAN device may turn on a switch, activate an output, send a notification to another device, or the like.

FIG. 5 shows a system diagram of an example WLAN with multiple spatial links for detecting motion. In the system 500, both the first WLAN device 110 and the second WLAN device 520 are multi-antenna devices. The first WLAN device 110 has the first antenna 113 and the second antenna 117 as described in FIG. 1. However, different from FIG. 1, the second WLAN device 520 includes multiple antennas (first AP antenna 522, second AP antenna 525, and third AP antenna 527). Although the second WLAN device 520 is described as an AP, in other systems, the second WLAN device 520 may be a station (STA), peer WLAN device, or other device capable of sending or receiving wireless signals. The example in FIG. 5 is based on 2×3 MIMO communications. When referring to MIMO communications, MxN refers to M RX antennas and N spatial streams. Thus, a 2×3 MIMO example occurs when the first WLAN device 110 has 2 antennas and can receive 3 different spatial streams (which may originate from 3 TX antennas as the second WLAN device 520 in this example). For this example, the second WLAN device 520 may be transmit WLAN communications received by the first WLAN device 110. However, just as described in FIG. 1, the technique could use WLAN communications from the first WLAN device 110 to the second WLAN device 520 and corresponding feedback information.

Each combination of spatial stream (SS) (at the second WLAN device 520) and RX antenna (at the first WLAN device 110) may define a spatial link. In this example, there would be M*N spatial links (link 1, link 2, . . . link M*N). As shown in FIG. 5, there are 6 wireless spatial links between the first WLAN device 110 and the second WLAN device 520. When determining the metric (herein referred to as spatial difference metric), the first WLAN device 110 may determine the difference between spatial signal processing characteristics between two different spatial links. Thus, the total quantity of spatial links may be grouped into pairs and each pair would have a spatial signal diversity metric. There are MN*(MN−1)/2 possible pairs of spatial links. For example, in a 2×3 scenario, there are 6 spatial links (link1 to link6) and 15 pairs (link1-link2, link1-link3, link1-link4, link1-link5, link1-link6 and so on to link5-link6). For each pair of spatial links, a first metric (representing antenna differences for a first WLAN communication) and a second metric (representing antenna differences for a second WLAN communication) may be determined. Then the first metric and the second metric are compared to determine whether the change is above a comparison threshold.

In some implementations, the first WLAN device 110 may determine that motion has occurred in the environment based on how many pairs of spatial links have a change above a comparison threshold. For example, there may be 3 pairs of spatial links that exhibit a change above the comparison threshold. If the threshold quantity of pairs is “2” then the first WLAN device 110 may determine that motion has been detected. However, if the threshold quality of pairs is “4,” then the first WLAN device 110 may not determine a motion detection. The threshold quantity may be user-configurable, system-configurable, or predetermined. In some implementations, the threshold quantity may be determined based on the total quantity of spatial links.

As shown in FIG. 5, the first WLAN device 110 includes a motion detection unit 550. The motion detection unit 550 may determine that there are 15 possible link pairs 552. A comparison unit 554 may compare the spatial difference metrics (between a first WLAN communication and a second WLAN communication) for each link pair. The motion detection unit 550 may store a threshold 556, such as a threshold quantity of pairs that are used to determine that motion has been detected.

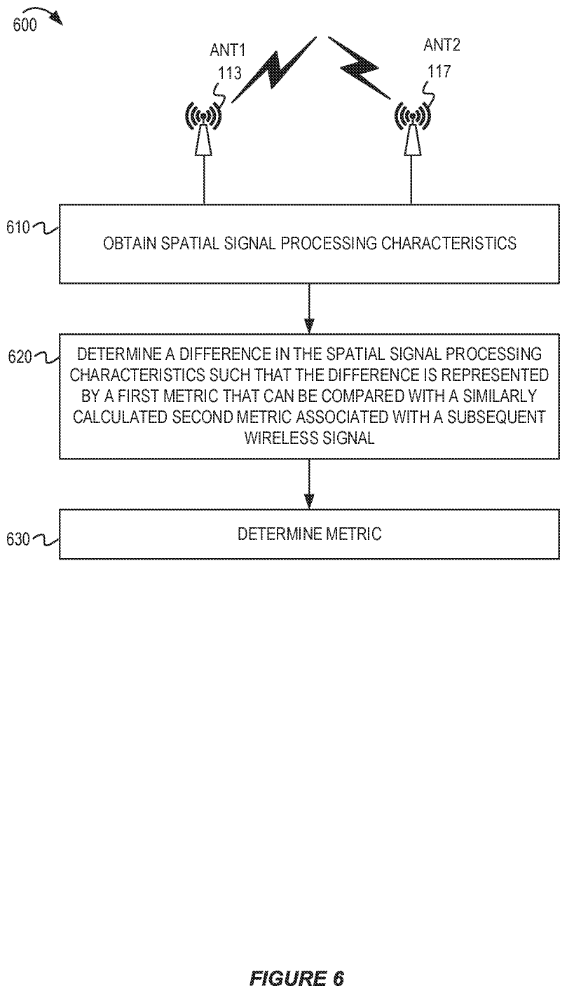

FIG. 6 shows a flowchart with descriptions of example calculations for determining a metric based on spatial signal processing characteristics. The flowchart 600 shows that a wireless signal may be received by both a first antenna 113 and a second antenna 117. At block 610, the first WLAN device 110 may obtain spatial signal processing characteristics associated with the wireless signal. For example, the spatial signal processing characteristics may include a matrix associated with different signal processing characteristics for a MIMO channel. The MIMO channel may be represented by the matrix H in the equation (1):

y=Hx (1)

where x is a vector of signals transmitted from the N antennas of the second WLAN device 120 and y is the signal received by the M antennas of the first WLAN device 110.

At block 620, the first WLAN device 110 (or the second WLAN device 120) may determine a difference in the spatial signal processing characteristics such that the difference is represented by a first metric that can be compared with a similarly calculated second metric associated with a subsequent wireless signal. There are several possible ways to determine the metric, which is output at block 630.

This disclosure includes various ways to calculate the metric based on spatial signal processing characteristics, which are described below. Some calculations may be used in combination with other described combinations.

### Right Singular Vectors

In one example, using the matrix H associated with the spatial signal processing characteristics, it is possible to perform a singular value decomposition in the equation (2) to obtain different portions.

H=USV* (2)

The matrix V* refers to the conjugate transpose, Hermitian transpose, or other transpose of the matrix V. Using the matrix H, it is possible to determine the matrix V* using a matrix decomposition calculation. Another calculation can be performed to determine the matrix V from the transpose matrix V*. Matrix V may represent the right singular vectors which can be provided by the second WLAN device 120 to the first WLAN device 110 as compressed beamforming feedback. The matrix S represents the gains for the different singular modes and also can be provided in feedback to the first WLAN device 110. The first WLAN device 110 may use the differences in the properties of matrix V to detect motion. For example, the phase or amplitude differences in the coefficients in matrix V may be calculated to determine the metric for a particular wireless signal.

### Dominant Singular Vector

In another example, it is possible to use the dominant singular vector. For example, the first WLAN device 110 (or the second WLAN device 120 providing feedback) may determine the dominant singular vector from the matrix V for the MIMO channel represented by matrix H of the singular value decomposition (see equation (2)).

One column in matrix V may be referred to as the dominant singular vector. The dominant singular vector (referred to here as v₀) may be the column associated with the strongest gain in the diagonal of the matrix S.

When comparing the first metric (for a first wireless signal or a first WLAN communication) to the second metric (for a second wireless signal or a second WLAN communication), the first WLAN device 110 may compare the dominant singular vectors (v₀₁ and v₀₂) representing the channel at time t1 and time t2. A measure, d, of the change in the channel from time t1 to time t2 can now be expressed as the following equation (3):

$$0 \leq δ = abs ( \frac{{v}_{01}^{*} {v}_{02}}{‖ {v}_{01} ‖ ‖ {v}_{0 \; 2} ‖} ) \leq 1 \qquad ( 3 )$$

If the metric, or a filtered version of it, is below some threshold the first WLAN device 110 may determine that movement is present. Examples of such filtering can be averaging across tones, weighted with the channel gain per tone, and time.

### Using Simplification of Decompression

In some implementations, it may be possible to further simplify the information available from compressed beamforming feedback. In case only the compressed form of the V matrix (along with the gains along the diagonal of the S matrix) is available to the higher software layers in the modem, then the CBF may be simplified in some implementations. One way of simplifying the decompression of the fed back V matrix is for the first WLAN device 110 to instruct the second WLAN device 120 to only feedback the dominant singular vector, such as one column of V. Then the first WLAN device 110 would only have one column of V to decompress. The decompressed column of V is now the dominant (right) singular vector which can be used for motion detection as described earlier. It also may be possible to directly use changes in the compressed form of V, especially if it only represents a single singular vector, to detect motion.

### Variation Using Set of Singular Vectors

Another example metric may measure the combined change in a set of singular vector of the channel. Assume we have a singular vector decomposition (equation (2)) of the channel. For example, this may be the singular value decomposition of the channel on a single tone.

Thus, the first WLAN device 110 can determine the right singular vectors in V and their gains represented by the diagonal elements of the matrix S at two points in time t1 and t2, which can be referred to as matrices S₁, V₁, S₂ and V₂. Assuming the gains of the singular vectors are different, the first WLAN device 110 can now form a metric using the following equation (4):

$$δ = \sqrt{{\sum }_{l = 1}^{L} {\vert {s}_{l} \vert}^{2} {\vert \frac{{v}_{l 1}^{*} {v}_{l 2}}{‖ {v}_{l 1} ‖ ‖ {v}_{l 2} ‖} \vert}^{2}} \qquad ( 4 )$$

where L is the number of singular vectors considered, or some variant of this.

This metric can then be accumulated or averaged over all the tones available and when it is above some threshold, motion can be indicated. The square root function may not needed but may be used for mathematical consistency in some implementations.

### Using Complete Channel Vector H

In some implementations, the beamforming feedback may include the full channel matrix H. In this case, the first WLAN device 110 may compute the dominant singular vector, left or right, for the matrix H using a singular value decomposition (such as a block power method). When the full channel matrix H is available, the first WLAN device 110 also can measure changes in the spatial signal processing characteristics observed from either the receive or the transmit (left or right) side of the MIMO channel, from or to a single antenna. That is, we can measure changes in the column vectors hₙ, n=1, . . . , N using equation (5), where:

H=[h₁ h₂ . . . h_{N}] (5)

or in the row vectors hₘ m=1, . . . , M using equation (6), where

$$H = [ \begin{matrix}{h}_{1} \\ {h}_{2} \\ ⋮ \\ {h}_{M}\end{matrix} ] \qquad ( 6 )$$

In some implementations, the vectors may be represented by the following formulas (7) or (8):

$$\begin{matrix}δ = {\sum }_{k ∈ set of tones} {\sum }_{n = 1}^{N} \vert \frac{{h}_{kn 1}^{*} {h}_{kn 2}}{‖ {h}_{kn 1} ‖ ‖ {k}_{kn 2} ‖} \vert \\ or & ( 7 ) \\ δ = {\sum }_{k ∈ set of tones} {\sum }_{m = 1}^{M} \vert \frac{{h}_{km 1}^{*} {h}_{km 2}}{‖ {h}_{km 1} ‖ ‖ {k}_{km 2} ‖} \vert & ( 8 )\end{matrix}$$

### Averaging or Discarding Portions of the Spatial Signal Processing Characteristics

In some implementations, the first WLAN device may manipulate the spatial signal processing characteristics before determining the metric. For example, some tones (which also may be referred to as frequencies) of an OFDM transmission may have a low signal power (or amplitude, magnitude, gain value, or the like). The spatial signal processing characteristics for these tones may be less reliable or may cause false positives in the motion detection step. For example, the tones with low signal power may be associated with a noisy channel or less reliable phase estimation. Therefore, in some implementations, the first WLAN device may filter or discard the values associated with these tones before determining the metric. For example, a signal power threshold may be used to determine which tones are associated with low power, and the values associated with those tones may be discarded. In some implementations, the first WLAN device may average some or all of the spatial signal processing characteristics for the various tones in the OFDM transmission before determining the metric.

### Hausdorff Metric

In another example, the matrices may be used to calculate a Hausdorff metric. The Hausdorff metric can be used to estimate the change in the properties of matrix V and matrix S combined. For example, the vectors in matrix V, combined with the gains in matrix S, may be used to define a multi-dimensional ellipsoid in a complex vector space using the following formula (9):

y=VSx, where x∈C^{K} and ∥x∥=1 (9)

The set of the vectors y lie on the surface of a multi-dimensional ellipsoid in C^{N}. By comparing the surfaces of these multi-dimensional ellipsoids, it is possible to evaluate how the channel changes from one wireless signal to the next over time.

An example of a metric that quantifies how two such multi-dimensional ellipsoids of dimensionality K in C^{N} is the Hausdorff distance. The Hausdorff distance between two multi-dimensional surfaces, such as ellipsoids, is defined using formulas (10-12) as:

$$δ ( E , F ) = max \{ {sup}_{y ∈ F} {inf}_{x ∈ F} ‖ x - y ‖ , {sup}_{x ∈ E} {inf}_{y ∈ F} ‖ x - y ‖ \} \qquad ( 10 )$$

where the surfaces (sets) E and F, respectively, are defined as

F is the set of y s.t. y=V_{F}S_{F}x, where x∈C^{K} and ∥x∥=1 (11)

and

E is the set of y s.t. y=V_{E}S_{E}x, where x∈C^{K} and ∥x∥=1 (12)

Here F and E, as sets and as indices, represent the spatial signal processing characteristics and indices for the two channels being compared. When the Hausdorff distance between two different channels in time, or a filtered version thereof, exceed a threshold we would deem that there is motion present. Examples of such filtering can be averaging across tones and time.

Adjusting Phase Values Associated with Random Phase Difference

In some implementations, the first WLAN device may have a random phase difference between RX antennas. To prevent false motion detection, the first WLAN device may normalize the metric by adjusting for the random phase difference. The first WLAN device may determine a range of the random phase difference. For example, the random phase may be either +pi or −pi. To adjust the metric, the first WLAN device may perform a comparison of the metric with a previous or next metric associated with a previous or next wireless signal. For example, if the change of the phase difference between two metrics for two wireless signals at different times is close to +pi, the first WLAN device may remove +pi from one of the metrics to adjust the comparison before detecting for motion. If the change of the phase difference between two metrics for two wireless signals at different times is close to −pi, the first WLAN device may remove −pi from one of the metrics to adjust the comparison before detecting for motion. In some implementations, the first WLAN device may use a threshold to determine if the change is due to a random phase change or not. For example, if the change is half of the range then the first WLAN device may determine that the change is based on the random phase difference rather than motion. For example, if the change is >+pi/2, the first WLAN device may adjust the metric to account for the random phase of +pi. If the change is <−pi/2, the first WLAN device may adjust the metric to account for the random phase of −pi.

### Correcting Random Phase Difference

In some implementations, the first WLAN device may correct the random phase difference to prevent false positives. Below is an algorithm for overcoming random phase difference:

Get the CSI at time t1 (for a first wireless signal), i.e., CSI(t1). It has [H11(t1), H12(t1), H13(t1), . . . , H1N(t1)], in total N tones for antenna 1, and [H21(t1), H22(t1), H23(t1), . . . , H2N(t1)], in total N tones for antenna 2.

Compute a first set of phase values regarding the CSI(t1), i.e., [phase11(t1), phase12(t1), phase13(t1), . . . , phase1N(t1)], in total N phases for antenna 1, and [phase21(t1), phase22(t1), phase23(t1), . . . , phase2N(t1)], in total N phases for antenna 2.

Calculate a first set of phase differences between two antennas, i.e., phaseDiff1(t1)=phase21(t1)−phase11(t1), phaseDiff2(t1)=phase22(t1)−phase12(t1), . . . , phaseDiffN(t1)=phase2N(t1)−phase1N(t1), in total N phase differences.

Repeat the above three steps to get the CSI at time t2 (for a second wireless signal), compute the second set of phase values regarding CSI(t2), and calculate a second set of phase differences between two antennas to get phaseDiff1(t2), phaseDiff2(t2), phaseDiffN(t2), in total N phase differences.

Compute how much the phase difference has changed from t1 to t2 and get, phaseChange1(t2)=phaseDiff1(t2)−phaseDiff1(t1), phaseChange2(t2)=phaseDiff2(t2)−phaseDiff2(t1), . . . , phaseChangeN(t2)=phaseDiffN(t2) −phaseDiffN(t1), in total N phase changes.

If there is a random phase difference between antenna 1 and antenna 2, this random phase difference will be common for all N phase changes. To remove the random phase difference, compute the delta phase between two adjacent tones, i.e., phaseDelta1(t2)=phaseChange2(t2) −phaseChange1(t2), phaseDelta2(t2)=phaseChange3(t2) −phaseChange2(t2), phaseDeltaN−1(t2)=phaseChangeN(t2) −phaseChangeN−1(t2), in total N−1 phase deltas.

Determine which tones are associated with low power by comparing the magnitude to a threshold (such as a signal power threshold), discard the values for the tones with low power, and do average for the remaining tones to get phaseDeltaAvg(t2). Here average could be 1) mean(absolute(phaseDelta)), i.e., get the absolute value of phase delta, then compute average, or 2) mean(phaseDelta\hat{ }2), that is mean square, or sqrt(mean(phaseDelta\hat{ }2)), that is root mean square (RMS).

Compare the average with a threshold (such as a phase delta threshold) and decide if motion is detected or not based on if the average is above or below the threshold. The phase delta threshold may be used to determine if the average phase delta is large enough to indicate motion.

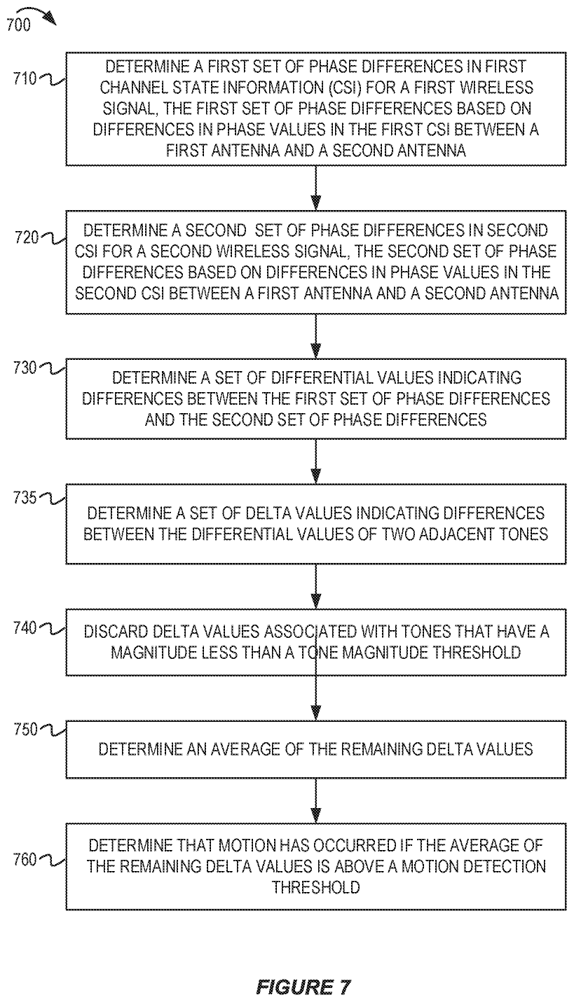

FIG. 7 shows a flowchart 700 with example operations for detecting motion based on channel state information while mitigating false positives associated with random phase differences. The flowchart 700 begins at block 710. At block 710, the first WLAN device 110 may determine a first set of phase differences in first channel state information (CSI) for a first wireless signal. The first set of phase differences may be based on differences in phase values in the first CSI between a first antenna and a second antenna. For example, the first WLAN device may determine a first set of phase values based on the first CSI per tone for each of the first antenna and the second antenna. The first WLAN device may determine the first set of phase differences based on a difference between the first set of phase values for the first antenna and the second antenna.

At block 720, the first WLAN device may determine a second set of phase differences in second CSI for the second wireless signal. The second set of phase differences may be based on differences in phase values in the second CSI between the first antenna and the second antenna. For example, the first WLAN device may determine a second set of phase values based on the second CSI per tone for each of the first antenna and the second antenna. The first WLAN device may determine the second set of phase differences based on a difference between the second set of phase values for the first antenna and the second antenna.

At block 730, the first WLAN device may determine a set of differential values indicating differences between the first set of phase differences and the second set of phase differences.

At block 735, the first WLAN device may determine a set of delta values indicating differences between the differential values of two adjacent tones.

At block 740, the first WLAN device may discard delta values associated with tones that have a magnitude less than a tone magnitude threshold.

At block 750, the first WLAN device may determine an average of the remaining delta values.

At block 760, the first WLAN device may determine that motion has occurred if the average of the remaining delta values is above a motion detection threshold.

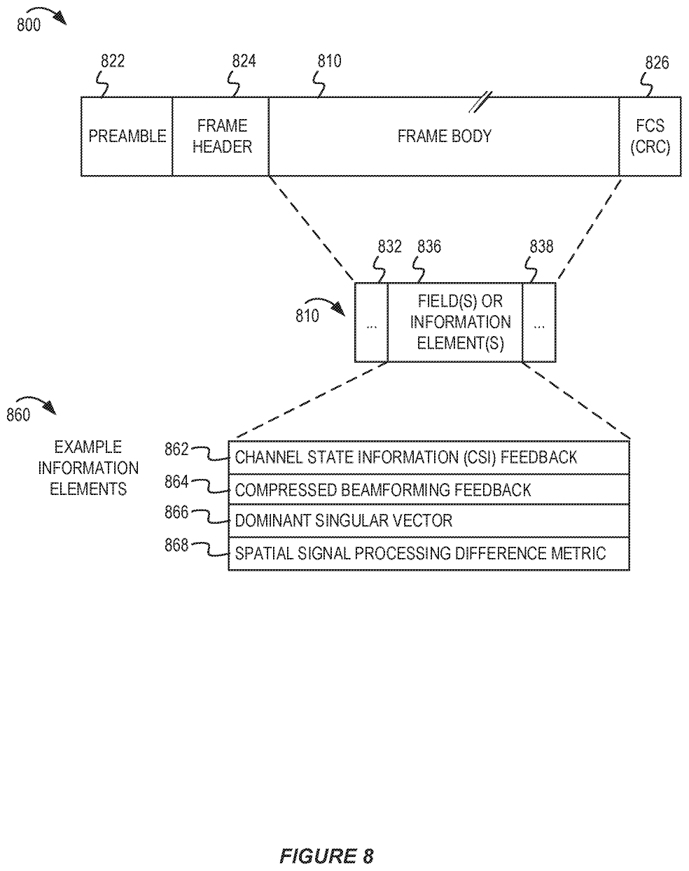

FIG. 8 shows an example conceptual message format with feedback for detecting motion based on spatial signal processing characteristics. For example, the message may be sent from a second WLAN device 120 to the first WLAN device 110. FIG. 8 includes an example data frame 820. The data frame 820 may include a preamble 822, a frame header 824, a frame body 810, and a frame check sequence (FCS) 826. The preamble 822 may include one or more bits to establish synchronization. The frame header 824 may include source and destination network addresses (such as the network address of the sending AP and receiving AP, respectively), the length of data frame, or other frame control information. The frame body 810 may be organized with a message format and may include a variety of fields or information elements 832, 836 and 838.

Various fields or information elements may be used to share feedback to the first WLAN device 110. Several examples of information elements 860 are illustrated in FIG. 8. The information elements may include CSI feedback 862, CBF 864, a dominant singular vector 866 from the beamforming feedback, or a custom spatial signal processing difference metric 868. For example, the spatial signal processing difference metric 868 may be a single value metric to represent a difference in antenna signal processing for on a wireless signal to or from multiple antennas. The spatial signal processing difference metric 868 may be calculated by the second WLAN device 120 and sent back to the first WLAN device 110 in a new WLAN message type used for motion detection.

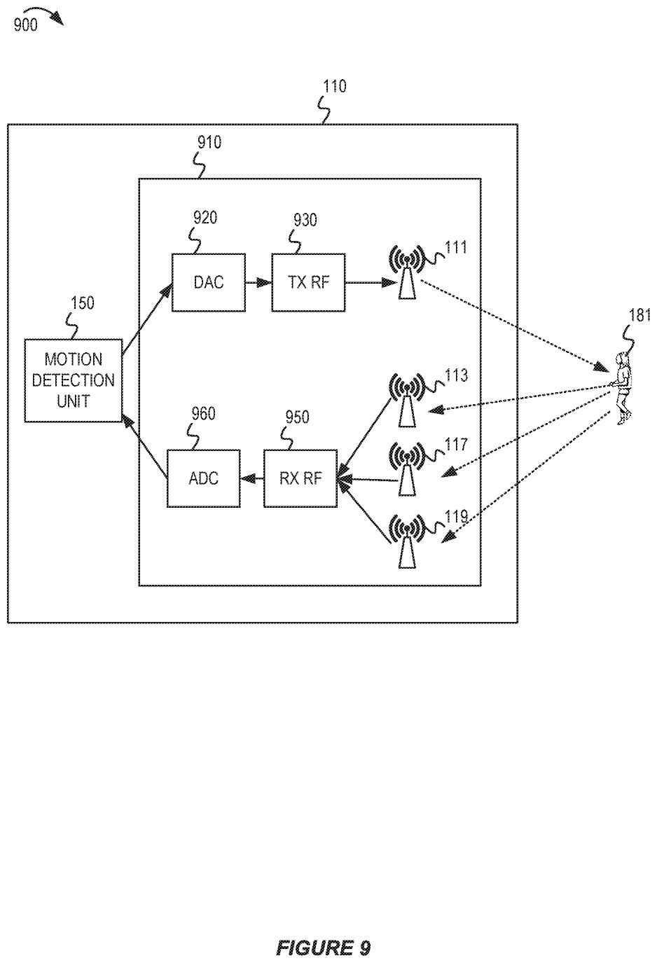

FIG. 9 shows a system diagram of a WLAN interface capable of detecting motion using reflections of wireless signals. The system diagram 900 shows a first WLAN device 110 which has a WLAN interface 910. The WLAN interface 910 may include multiple antennas 111, 113, 117, and 119. In addition the WLAN interface 910 may have a digital to analog converter (DAC) 920, a transmit radio frequency (TX RF) component 930, a receive radio frequency component (RX RF) component 950, and an analog to digital converter (ADC) 960. There may be other components (not shown) in the WLAN interface.

In some implementations, the WLAN interface 910 may use wireless signals sent and received by various antennas to detect motion of the person 181 based on wireless signal reflections. The wireless signals may not be formatted according to a WLAN communication. For example, the motion detection unit 150 may cause transmission of a wireless signal through the DAC 920 without formatting the wireless signal through a WLAN baseband (or other) component (not shown) of the WLAN interface 910. The wireless signal may be injected directly to the DAC 920 so that it can be sent through the TX RF component 930 and at least one antenna 111. It is noted that the antenna used to transmit the wireless signal may be different from the antennas used to receive the wireless signal reflections. The wireless signal reflections may be received by two or more antennas 113, 117, 119, the RX RF component 950, and the ADC 960. The motion detection unit 150 may capture the received wireless signal reflections directly form the ADC 960. The motion detection unit 150 may process the captured received wireless signal reflections to get channel estimation and detect motion. In some implementations, the motion detection unit 150 may determine distance or direction of travel based on the wireless signal reflections captured from the ADC 960.

The format of the transmitted wireless signal may or may not be formatted according to a WLAN communication (such as a WLAN packet or frame). For example, the wireless signal may have a MAC header and PHY preamble which are used WLAN decoding. However, in this implementations, the wireless signal may be formatted without a MAC header or PHY preamble. For example, the wireless signal may be a predetermined sequence having good correlation properties. Examples of sequences with good correlation properties include Zadoff-Chu sequences, zero side-lobes Complementary Golay codes, Pseudo Noise (PN) sequences, or the like.

In some implementations, the predetermined sequence is transmitted using one antenna, while other antennas receive the reflections and capture ADC samples. The motion detection unit 150 may process the ADC samples by doing correlation between the ADC samples and the known transmitted predetermined sequence to estimate channel information. As shown in the example of FIG. 9, with one antenna transmitting and three antennas receiving, the motion detection unit 150 may get a 1×3 channel estimation based on the wireless signal reflections.

The example of FIG. 9 may be one variation in which a single WLAN interface may transmit a wireless signal and receive the wireless signal reflections using different antennas. Other variations may be possible. For example, the WLAN interface 910 may send a short pulse via one or more antennas and then quickly switch from transmit to receive so that the antennas may be used to receive the wireless signal reflections of the short pulse. In some implementations, the WLAN interface 910 may use one antenna to transmit and use four antennas to receive to get 1×4 channel estimation.

In some implementations, the motion detection unit 150 may generate MIMO signals that can be stored in memory and injected to DAC 920. For example, the motion detection unit 150 may generate 2-stream signals, send from a first subset of antennas (such as antennas 111 and 113), and receive the signal reflections using a second subset of antennas (such as antennas 117 and 119). The motion detection unit 150 may use the wireless signal reflections captured form the ADC to estimate 2×2 MIMO channel estimates. In another variation, the motion detection unit 150 may generate 3-stream signals, send from a first subset of antennas (such as antennas 111, 113, 117) and receive the reflections of the 3-stream signal using another subset of antennas (such as antenna 119). The motion detection unit 150 may use the wireless signal reflections captured form the ADC to estimate 3×1 MIMO channel estimates.

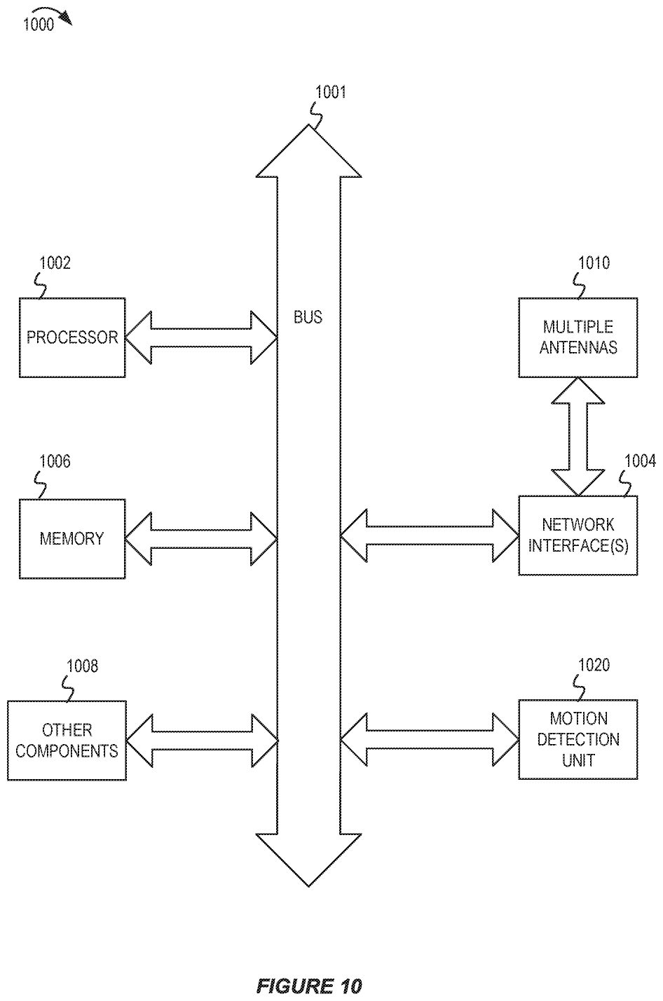

FIG. 10 shows a block diagram of an example electronic device 1000 for implementing aspects of this disclosure. In some implementations, the electronic device 1000 may be a WLAN device (such the first WLAN device 110). The electronic device 1000 includes a processor 1002 (possibly including multiple processors, multiple cores, multiple nodes, or implementing multi-threading, etc.). The electronic device 1000 includes a memory 1006. The memory 1006 may be system memory or any one or more of the below-described possible realizations of machine-readable media. The electronic device 1000 also may include a bus 1001 (such as PCI, ISA, PCI-Express, HyperTransport®, InfiniBand®, NuBus, AHB, AXI, etc.). The electronic device may include one or more network interfaces 1004, which may be a wireless network interface (such as a wireless local area network, WLAN, interface, a Bluetooth® interface, a WiMAX interface, a ZigBee® interface, a Wireless universal serial bus, USB, interface, or the like) or a wired network interface (such as a powerline communication interface, an Ethernet interface, etc.). In some implementations, electronic device 1000 may support multiple network interfaces 1004—each of which may be configured to couple the electronic device 1000 to a different communication network.

The memory 1006 includes functionality to support various implementations described above. The memory 1006 may include one or more functionalities that facilitate implementations of this disclosure. For example, memory 1006 can implement one or more aspects of the first WLAN device 110. The memory 1006 can enable implementations described in FIGS. 1-9 above. The electronic device 1000 also may include other components 1008.

The electronic device 1000 may include a motion detection unit 1020 (such as the motion detection unit 150 or the motion detection unit 550). The motion detection unit 1020 may gather information from multiple antennas 1010 to determine metrics for wireless signals detected by a WLAN interface. For example, the motion detection unit 1020 may gather spatial signal processing characteristics which can be used to calculate differences between the multiple antennas 1010. The motion detection unit 1020 may compare the metrics over time to determine a change which indicates motion in the environment as described above.

Any one of these functionalities may be partially (or entirely) implemented in hardware, such as on the processor 1002. For example, the functionality may be implemented with an application specific integrated circuit, in logic implemented in the processor 1002, in a co-processor on a peripheral device or card, etc. Further, realizations may include fewer or additional components not illustrated in FIG. 10 (such as video cards, audio cards, additional network interfaces, peripheral devices, etc.). The processor 1002, and the memory 1006, may be coupled to the bus 1001. Although illustrated as being coupled to the bus 1001, the memory 1006 may be directly coupled to the processor 1002.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends on the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-Ray™ disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine-readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or delta of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method performed by a wireless local area network (WLAN) interface of a first WLAN device, comprising:
determining a first metric based, at least in part, on a first difference between first spatial signal processing characteristics regarding a first wireless signal received at a first antenna of the WLAN interface and a second antenna of the WLAN interface;
determining a second metric based, at least in part, on a second difference between second spatial signal processing characteristics regarding a second wireless signal received at the first antenna and the second antenna; and
determining that a motion has occurred based, at least in part, on a change from the first metric to the second metric.

2. The method of claim 1, wherein the first wireless signal includes a first WLAN communication from a second WLAN device to the first WLAN device, and wherein the second wireless signal includes a second WLAN communication from the second WLAN device to the first WLAN device.

3. The method of claim 1, wherein the first wireless signal and the second wireless signal are wireless signal reflections of wireless signals transmitted from the first WLAN device.

4. The method of claim 1, wherein the first spatial signal processing characteristics regarding the first wireless signal are based on beamforming feedback from a second WLAN device, and wherein the second spatial signal processing characteristics regarding the second wireless signal are based on beamforming feedback from the second WLAN device.

5. The method of claim 1, wherein the first difference between the first spatial signal processing characteristics includes a phase difference at the first antenna and the second antenna for the first wireless signal.

6. The method of claim 1, further comprising determining that the motion has occurred when a difference between the first metric and the second metric is above a comparison threshold.

7. The method of claim 1,
wherein determining the first metric includes:
determining channel state information (CSI) based on the first wireless signal, the CSI including the first spatial signal processing characteristics for each of a first spatial link at the first antenna and a second spatial link at the second antenna, and
determining the first difference between the first spatial signal processing characteristics associated with the first spatial link and the second spatial link; and
wherein determining the second metric includes:
determining CSI based on the second wireless signal, the CSI including the second spatial signal processing characteristics for each of the first spatial link and the second spatial link, and
determining the second difference between the second spatial signal processing characteristics associated with the first spatial link and the second spatial link.

8. The method of claim 1,
wherein determining the first metric includes:
receiving the first wireless signal from a second WLAN device, via a first spatial link at the first antenna and a second spatial link at the second antenna,
determining a first set of channel estimates for the first spatial link and the second spatial link based on the first wireless signal, and
determining the first difference between the first set of channel estimates for the first spatial link and the second spatial link; and
wherein determining the second metric includes:
receiving the second wireless signal from the second WLAN device, via the first spatial link at the first antenna and the second spatial link at the second antenna,
determining a second set of channel estimates for the first spatial link and the second spatial link based on the second wireless signal, and
determining the second difference between the second set of channel estimates for the first spatial link and the second spatial link.

9. The method of claim 1,
wherein determining the first metric includes:
sending the first wireless signal via the WLAN interface, wherein the first wireless signal causes a reflection from a stationary object that is received as a first wireless signal reflection;
receiving the first wireless signal reflection via a first spatial link at the first antenna and a second spatial link at the second antenna,
determining a first set of channel estimates for the first spatial link and the second spatial link based on the first wireless signal reflection, and
determining the first difference between the first set of channel estimates for the first spatial link and the second spatial link; and
wherein determining the second metric includes:
sending the second wireless signal via the WLAN interface, wherein the second wireless signal causes a reflection that is received as a second wireless signal reflection;
receiving the second wireless signal reflection via the first spatial link at the first antenna and the second spatial link at the second antenna,
determining a second set of channel estimates for the first spatial link and the second spatial link based on the second wireless signal reflection, and
determining the second difference between the second set of channel estimates for the first spatial link and the second spatial link.

10. The method of claim 1,
wherein determining the first metric includes:
sending the first wireless signal to a second WLAN device,
receiving, from the second WLAN device, first compressed beamforming information in response to the first wireless signal, and
determining the first metric based on the first compressed beamforming information; and
wherein determining the second metric includes:
sending the second wireless signal to the second WLAN device,
receiving, from the second WLAN device, second compressed beamforming information in response to the second wireless signal, and
determining the second metric based on the second compressed beamforming information.

11. The method of claim 1,
wherein determining the first metric includes:
sending the first wireless signal to the second WLAN device,
receiving, from the second WLAN device, a first dominant singular vector from a first channel matrix associated with beamforming information regarding the first wireless signal, and
determining the first metric based on the first dominant singular vector; and
wherein determining the second metric includes:
sending the second wireless signal to the second WLAN device,
receiving, from the second WLAN device, a second dominant singular vector from a second channel matrix associated with beamforming information regarding the second wireless signal, and
determining the second metric based on the second dominant singular vector.

12. The method of claim 1,
wherein determining the first metric includes averaging values in the first spatial signal processing characteristics for a set of tones before determining the first difference between the first antenna and the second antenna, and
wherein determining the second metric includes averaging values in the second spatial signal processing characteristics for a same set of tones before determining the second difference between the first antenna and the second antenna.

13. The method of claim 1,
wherein determining the first metric includes discarding values in the first spatial signal processing characteristics for a subset of tones before determining the first difference between the first antenna and the second antenna, and
wherein determining the second metric includes discarding values in the second spatial signal processing characteristics for a same subset of tones before determining the second difference between the first antenna and the second antenna.

14. The method of claim 13, further comprising:
determining the set of tones in an orthogonal frequency division multiplexing (OFDM) transmission that are associated with low signal power below a signal power threshold; and
discarding the values in the first spatial signal processing characteristics for the set of tones.

15. The method of claim 1, further comprising:
determining a random phase difference at the first WLAN device;
determining that a difference from the first metric to the second metric is due to the random phase difference; and
adjusting the first metric or the second metric to remove the random phase difference.

16. The method of claim 15, wherein determining that the difference from the first metric to the second metric is due to the random phase difference includes:
determining a range for the random phase difference, the range having a positive range value and a negative range value; and
determining that the difference from the first metric to the second metric is more than half of the positive range value or less than half of the negative range value.

17. The method of claim 1,
wherein determining the first metric includes determining a first set of phase differences in first channel state information (CSI) for the first wireless signal, the first set of phase differences based on differences in phase values in the first CSI between the first antenna and the second antenna;
wherein determining the second metric includes determining a second set of phase differences in second CSI for the second wireless signal, the second set of phase differences based on differences in phase values in the second CSI between the first antenna and the second antenna; and
wherein determining that a motion has occurred includes:
determining a set of differential values indicating differences between the first set of phase differences and the second set of phase differences,
determining a set of delta values indicating differences between the differential values of two adjacent tones,
discarding delta values associated with tones that have a magnitude less than a tone magnitude threshold,
determining an average of the remaining delta values, and
determining that motion has occurred if the average of the remaining delta values is above a motion detection threshold.

18. The method of claim 1, further comprising:
determining a plurality of metrics associated with a sequence of wireless signals, wherein each metric of the plurality of metrics is based on based on a difference between spatial signal processing characteristics for a respective wireless signal at the first antenna and the second antenna;
determining a pattern in the plurality of metrics over the sequence of wireless signals; and
determining the motion based on a change in the pattern.

19. The method of claim 18,
wherein determining the pattern includes determining a multi-dimensional ellipsoid shape representing the plurality of metrics, and
wherein determining the motion includes comparing changes in a surface of the multi-dimensional ellipsoid shape over time.

20. The method of claim 18, further comprising:
using the plurality of metrics as indices for a Hausdorff distance calculation, wherein determining the motion includes comparing a result of the Hausdorff distance calculation with a comparison threshold.

21. The method of claim 18, further comprising:
determining a direction of the motion based, at least in part, on the pattern.

22. The method of claim 1, wherein the first wireless signal and the second wireless signal are beacon messages received by the first WLAN interface from an access point (AP).

23. The method of claim 1, wherein multiple spatial links exist between the first WLAN device and a second WLAN device, the method further comprising:
determining a plurality of link pairs from among the multiple spatial links;
for each link pair between the first WLAN device and the second WLAN device:
determining the first metric and the second metric associated with respective spatial links in the link pair;
determining the change from the first metric to the second metric for the link pair; and
detecting the motion in the environment based, at least in part, on a quantity of the link pairs that have the change above a comparison threshold.

24. The method of claim 23, wherein detecting the motion includes:
detecting the motion when the quantity of the link pairs that have the change above the comparison threshold is above a threshold quantity.

25. The method of claim 1, wherein the first WLAN device is part of a networked electrical system, the method further comprising:
activating a feature of the networked electrical system in response to determining that the motion has occurred.

26. The method of claim 1, wherein the first metric is a baseline metric determined at a time when no object is in motion.

27. An apparatus for use in a first wireless local area network (WLAN) device, comprising:
a WLAN interface; and
a processor coupled with the WLAN interface and configured to: determine a first metric based, at least in part, on a first difference between first spatial signal processing characteristics regarding a first wireless signal received at a first antenna of the WLAN interface and a second antenna of the WLAN interface;
determine a second metric based, at least in part, on a second difference between second spatial signal processing characteristics regarding a second wireless signal received at the first antenna and the second antenna; and
determine that a motion has occurred based, at least in part, on a change from the first metric to the second metric.

28. The apparatus of claim 27, wherein the first wireless signal and the second wireless signal are wireless signal reflections of wireless signals transmitted from the first WLAN device.

29. A non-transitory computer-readable medium having stored therein instructions which, when executed by a processor of a first wireless local area network (WLAN) device having a WLAN interface, cause the first WLAN device to:
determine a first metric based, at least in part, on a first difference between first spatial signal processing characteristics regarding a first wireless signal received at a first antenna of the WLAN interface and a second antenna of the WLAN interface;
determine a second metric based, at least in part, on a second difference between second spatial signal processing characteristics regarding a second wireless signal received at the first antenna and the second antenna; and
determine that a motion has occurred based, at least in part, on a change from the first metric to the second metric.

30. The non-transitory computer-readable medium of claim 29, wherein the first wireless signal and the second wireless signal are wireless signal reflections of wireless signals transmitted from the first WLAN device.
